(19) United States
(12) Patent Application Publication
(10) Pub. No.: US 2007/0146379 A1
(43) Pub. Date: Jun. 28, 2007

(54) OSD controlling method of display device for setting shapes of OSD menu

(75) Inventor: Wan-Chin Lai, Miao-Li (TW)

Correspondence Address: WEI TE CHUNG;FOXCONN INTERNATIONAL, INC., 1650 MEMOREX DRIVE, SANTA CLARA, CA, 95050, US

(73) Assignee: INNOLUX DISPLAY CORP.

(21) Appl. No.: 11/644,325

(22) Filed: Dec. 21, 2006

(30) Foreign Application Priority Data
Dec. 22, 2005 (CN) 200510121009.9

(51) Int. Cl. G09G 5/00

(52) U.S. Cl. 345/581

(57) ABSTRACT

An exemplary OSD controlling method of a display device includes: generating a controlling signal and sending the controlling signal to a micro-controller unit (MCU); and setting a shape parameter which is stored in a register and which is represented a shape of a menu of on screen display (OSD) according to the controlling signal by the MCU.

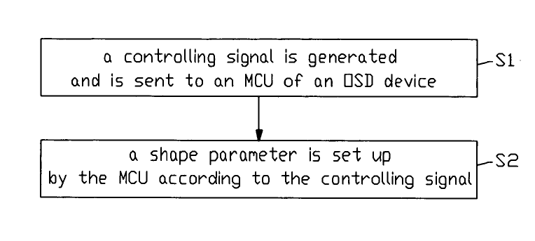

### FIELD OF THE INVENTION

The present invention relates an on-screen display (OSD) controlling method of a display device for setting all kinds of shapes of an OSD menu.

### GENERAL BACKGROUND

With the rapid popularization of computer related to peripheral fields these years, many display devices, e.g. cathode ray tube (CRT) display and liquid crystal display (LCD), have been increasingly playing an important role in these fields. The performance of these display devices essentially depends on the calibration of parameters beside the optimal parameters of manufacturers, e.g. contrast, brightness, vertical and horizontal sizes, and geometric shapes etc. The OSD provides users with interactive information to obtain a best display quality through the above parameters. There is a selection button for an OSD message display mode. An OSD device receives a demand signal and be sent to a micro-controller unit (MCU) in the OSD device to control precisely the contrast, brightness, vertical and horizontal sizes when users push the selection button inducing the demand signal. Further, the users can clearly observe the effect due to the adjustment of the parameters.

However, a shape of a OSD menu for a display device is designed to be an ellipse, a circle, a rectangle having round comers, or a multiwindow by the manufacturers before the display device is sold out. The shape of the OSD menu cann't be changed by users.

What is needed, therefore, is a controlling method for providing a user to set variable shapes of an OSD menu used in a display device according to personal favorite that can overcome the above-described deficiency.

### SUMMARY

In one preferred embodiment, a controlling method of a display device includes: generating a controlling signal and sending the controlling signal to a micro-controller unit (MCU); and setting a shape parameter which is stored in a register and which is represented a shape of a menu of on screen display (OSD) according to the controlling signal by the MCU.

Other advantages and novel features will become more apparent from the following detailed description when taken in conjunction with the accompanying drawings.

### BRIEF DESCRIPTION OF THE DRAWINGS

A drawing is a flow chart of a controlling method for providing variable shapes of a menu of an OSD used in a display device according to an exemplary embodiment of the present invention.

### DETAILED DESCRIPTION OF PREFERRED EMBODIMENTS

A drawing is a flow chart of a controlling method for providing variable shapes of a menu of an OSD used in a display device according to an exemplary embodiment of the present invention. The controlling method includes the following steps.

In step S1, a controlling signal is generated and is sent to a micro-controller unit (MCU) of an OSD system (not shown). The controlling signal can be generated by a shape option of anOSD menu, or by performing a special software in a computer, or by pressing a key combination of a keyboard.

In step S2, a shape parameter is set up by the MCU according to the controlling signal. The shape parameter is stored in a register of the OSD device. The register includes a memory unit such as an electrically erasable programmable read-only memory (EEPROM) functioned as a variable index represented the shape parameter. Each shape parameter relates to a predetermined shape of the OSD menu. Each predetermined shape of the OSD menu related to a sub-program. Each sub-program can be selected by a corresponding shape parameter. When the MCU receives the controlling signal and changes the variable index according to the controlling signal, a sub-program related to the changed variable index or changed shape parameter is performed. The sub-program is configured for producing a predetermined shape of the OSD menu on the display device.

Furthermore, in the step S2, a display controlling program is performed by the MCU when the shape parameter is set according to the controlling signal. The display controlling program is configured for pointing to the corresponding sub-program according to the related shape parameter. Thus a desired shape of the OSD menu can be displayed on the display device when the chosen sub-program is performed. The predetermined shape of the OSD menu is selected from a group consisting of rectangle, ellipse, circle, rectangle having round comers, and multiwindow.

Because the OSD device includes a memory unit functioned as a variable index represented the shape parameter which is related to a sub-program configured for displaying a predetermined shape of the OSD menu on the display device, the memory unit can select a sub-program according to the controlling signal. Thus a desired shape of the OSD menu can be displayed on the display device when the chosen sub-program is performed. Therefore users can select all kinds of the shapes of the OSD menu as they wish.

It is to be understood, however, that even though numerous characteristics and advantages of the present embodiments have been set out in the foregoing description, together with details of the structures and functions of the embodiments, the disclosure is illustrative only, and changes may be made in detail, especially in matters of shape, and arrangement of parts within the principles of the invention to the full extent indicated by the broad general meaning of the terms in which the appended claims are expressed.

What is claimed is:

1. An on screen display (OSD) controlling method of a display device comprising:
generating a controlling signal and sending the controlling signal to a micro-controller unit (MCU); and
setting a shape parameter which is stored in a register and which is represented a shape of a menu of on screen display (OSD) according to the controlling signal by the MCU.

2. The controlling method of a display device as claimed in claim 1, further comprising performing a display controlling program for pointing to a corresponding sub-program according to the related shape parameter.

3. The controlling method of a display device as claimed in claim 2, wherein the sub-program is selected by a related shape parameter.

4. The controlling method of a display device as claimed in claim 2, wherein the sub-program is configured for producing a predetermined shape of the OSD menu.

5. The common voltage adjusting circuit as claimed in claim 2, wherein the display controlling program is performed by the MCU when the shape parameter is set according to the controlling signal.

6. The controlling method of a display device as claimed in claim 1, wherein the controlling signal is generated by a shape option of an OSD menu.

7. The controlling method of a display device as claimed in claim 1, wherein the controlling signal is generated by a key combination of a keyboard.

8. The controlling method of a display device as claimed in claim 1, wherein the controlling signal is generated by performing a special software in a computer.

9. The controlling method of a display device as claimed in claim 1, wherein the register comprises a memory unit functioned as a variable index represented the shape parameter.

10. The controlling method of a display device as claimed in claim 1, wherein memory unit is an electrically erasable programmable read-only memory (EEPROM).

11. The controlling method of a display device as claimed in claim 1, wherein the shape of the OSD menu is selected from a group consisting of rectangle, ellipse, circle, rectangle having round comers, and multiwindow.

12. An on screen display (OSD) controlling method of a display device comprising steps of:
generating a controlling signal and sending the controlling signal to a micro-controller unit (MCU); and
setting a shape parameter which is represented a shape of a menu of on screen display (OSD) according to the controlling signal by the MCU.
